(19) United States
(12) Patent Application Publication
(10) Pub. No.: US 2012/0282356 A1
(43) Pub. Date: Nov. 8, 2012

(54) COMPOSITIONS FOR PREVENTION AGAINST SPOILAGE BY MOULDS AND YEASTS AND USES AND PRODUCTS RELATED THERETO

(75) Inventors: Elke Schrader, Verden/Aller (DE); Susan Finnegan, Wodonga (AU); Andrew Redman, Wodonga (AU); Arun Shastry, Franklin, TN (US); Monica Talsania, Batley (GB)

(73) Assignee: MARS INCORPORATED, McLean, VA (US)

(21) Appl. No.: 13/394,804

(22) PCT Filed: Sep. 3, 2010
(86) PCT No.: PCT/EP2010/005415

§ 371 Date: Jul. 27, 2012

(30) Foreign Application Priority Data
Sep. 8, 2009 (EP) 09011467.9

(51) Int. Cl. A01N 65/00; A01N 65/22; A01N 65/44; A01N 65/20; A23K 1/00; A01N 65/16; A01N 37/02; A01N 37/10; A01P 3/00; A01N 65/24; A01N 65/36

(52) U.S. Cl. 424/732; 424/725; 424/739; 424/745; 424/757; 424/736; 514/557; 514/570; 426/532

(57) ABSTRACT

The invention is related to compositions for prevention against spoilage by moulds and yeasts comprising, as the only antimycotic agents, at least one compound selected from organic acids selected from the group consisting of caprylic acid, cinnamic acid, propionic acid, butyric acid, lactic acid, tartaric acid and fumaric acid, and salts thereof, and at least one compound selected from plant of fruit extracts, the oily phases of plant or fruit extracts, and monosubstances derived from such extracts or oily phases thereof. The invention is furthermore related to the use of such or similar compositions for protection of food or feed products from growth of moulds and yeasts as well as to food or feed products containing such compositions.

The present invention relates to compositions for prevention against spoilage by moulds and yeasts and uses and products related thereto.

Industrially processed food and feed products have to be protected from deterioration by growth of microorganisms, such as fungi and bacteria. Whereas wet products are usually going through a retort process wherein food or feed is cooked and placed in a can or container for further sterilization and cooking to kill the microorganisms and dry products are not specifically endangered by growth of microorganisms because of their low moisture contents and water activities, there is specifically a problem with intermediate moisture foods and feeds, such as intermediate moisture pet food products having a moisture content of from about 10 to 40 wt.-% and a water activity in the range of from 0.60 to 0.90, in particular from 0.65 to 0.85. At these moisture levels, spoilage of the products is mainly related to spoilage caused by moulds and yeasts, and these microorganisms tend to deteriorate the products in terms of organoleptic properties or, in some instances, produce toxins.

Therefore, specific antimycotic compositions are usually added to such products. The prior art mostly uses antimycotic compositions based on sorbic acid, in particular sorbate, or benzoic acid, in particular benzoate. However, other microbiocidals for improving the shelf life of such products are known from the prior art.

For example, EP 0 762 837 B1 describes a method for the improvement of keeping the quality and/or stabilization of microbially perishable products wherein the surfaces of the products and/or the environment are treated with a microbiocidal composition comprising benzyl alcohol and at least one microbiocidally active GRAS (generally recognized as safe) flavoring agent, wherein said GRAS flavoring agent is selected from specific alcohols, aldehyds, phenols, acetates, acids, alicine, terpenes, acetals, polyphenols and essential oils. These compositions, however, mandatorily require the presence of benzyl alcohol and are not used as additives to the products.

Mixtures of organic acids and diols for antimicrobial compositions are described in EP 0 785 714 B1.

WO 2008/007245 A2 discloses a preservative system for pet food products based on at least one natural preservative, optionally further comprising a chelating agent, which might be one of some specific organic acids. The examples of WO 2008/007245 show an effect of these natural preservative systems to result in the delay in the breakdown of fat from oxidation. No effect against growth of microorganisms is discussed or shown in this prior art document.

WO 2009/063005 discloses food products comprising at least one salivating agent, preferably an organic acid, and at least one cooling agent as well as, optionally, a tingling agent, which might be a plant extract. The food products are set to have enhanced mouth and mental refreshment.

WO 2005/018333 disclose compositions comprising the antimicrobial nisin and an extract from a plant of the Labiatae family or preferably selected from rosemary, sage, oregano, marjoram, mint, balm, savoury and thyme.

U.S. Pat. No. 3,658,548 is directed to an animal food composition comprising caproic acid or caprylic acid to prevent mould growth.

WO 01/97799 is related to medium chain fatty acids, such as caproic acid and caprylic acid as antimicrobial agents.

The objective of the present invention therefore is to provide for a composition for effective protection of food or feed products, in particular intermediate moisture pet food products, but not restricted thereto, from the growth of moulds and yeasts, which are effective at specifically low concentration, and may additionally have a positive impact of palatability.

The objective is solved by a composition for prevention against spoilage by moulds and yeasts comprising, as the only antimycotic agents, at least one compound from group (a) and at least one compound from group (b):
(a) organic acids selected from the group consisting of caprylic acid, cinnamic acid, propionic acid, butyric acid, lactic acid, tartaric acid and fumaric acid, and salts thereof
(b) plant or fruit extracts, the oily phases of plant or fruit extracts, and monosubstances derived from such extracts or oily phases thereof.

In one embodiment the plant or fruit extract from group (b) is selected from cinnamon extract, in particular extract of cinnamon bark or cinnamon leaf, thyme extract, oregano extract, marjoram extract, lemon grass extract, cassia extract, geranium extract, grapefruit seed extract, cranberry extract and bilberry extract.

In a further embodiment the oily phase from group (b) is selected from the group consisting of cinnamon oil, lemon grass oil, thyme oil, lemon myrrth oil, oregano oil, teatree oil and clove oil.

Preferably, the monosubstance from group (b) is selected from the group consisting of cinnamon aldehyde, vanillin and functionally equivalent derivatives thereof.

In a preferred embodiment the organic acid from group (a) is caprylic acid, cinnamic acid, propionic acid or one or more salts thereof.

Furthermore, the component(s) from group (a) and the component(s) from group (b) may be present in the mass ratio of from 20:80 to 98.5:1.5, preferably from 70:30 to 98.5:1.5.

The invention is also related to the use of a composition comprising, as the only antimycotic agents, at least one compound of group (a′) and at least one compound of group (b), as defined in claims 1 to 4, or a content of at least two compounds from group (b), as defined in claims 1 to 4, wherein group (a′) comprises straight, branched of cyclic, mono or polyvalent organic acids having 3 to 10 carbon atoms, optionally hydroxy or oxo substituted, for protection of food or feed products from growth of moulds and yeasts.

The preferred use is for protection from growth of moulds and yeasts in a pet food product, a human food product, a confectionary product or as part of a packaging for a food or feed product for such purpose.

Preferably, the organic acid from group (a′) is selected from caprylic acid, cinnamic acid, levulinic acid, malic acid, propionic acid, butyric acid, lactic acid, tartaric acid, ascorbic acid, fumaric acid, citric acid and salts thereof.

Furthermore, the component(s) from group (a′) and the component(s) from group (b) may be present in the mass ratio of from 20:80 to 98.5:1.5, preferably from 70:30 to 98.5:1.5 .

Moreover, the invention is related to a food or feed product with a content of from 0.01% to 2.5%, preferably from 0.1% to 1.2%, most preferably from 0.25% to 0.9% by dry weight of the food or feed product, of a composition of the present invention.

Preferably, the food product is a pet food product, most preferably a pet food product having a moisture content of from 10 to 40 wt.-% and a water activity in the range from 0.60 to 0.90.

Most preferably, the pet food product has a water activity of from 0.65 to 0.85.

Although many uses of plant or fruit components or extracts in preparing human and pet foods are known for example for health benefits, flavor, taste, aroma, textual effects and color effects, the present invention is based on the surprising finding that there is an added benefit of some of those plant or fruit components or extracts, in particular when combined with one or more organic acids, to improve the shelf stability, in particular by preventing the growth of particular moulds and yeasts in food or feed products.

In the context of the present invention, “intermediate moisture pet food” is defined as a pet food product with a moisture content of from 10 to 40 wt. % and a water activity in the range of from 0.60 to 0.90.

It has now been surprisingly found that certain plant or fruit extracts and products or components derived therefrom have shown to provide in particular protective effects against moulds and yeasts in food or feed products, when added at levels up to about 2.5 wt.-%, in particular when combined with one or more organic acids. Specifically, those extracts, oils and components derived therefrom as specifically shown hereinabove have shown synergistic effects when two or more are used or when one or more thereof have been used with one or more of the organic acids mentioned hereinabove. Benefits of these synergistic effects include, but are not limited to:
(1) Usage of lower concentrations of the extract to prevent mould/yeast growth.
(2) Maximize the protection against a broader range of mould and yeast species.
(3) Positive impact on sensory perception of the owner through combination of extracts at significantly lower levels of each individual components then would otherwise be required.
(4) Minimize unpleasant order of flavors of the plant or fruit extracts by including them in significantly lower levels of each individual components then would otherwise be required.
(5) Usually no negative impact on palatability.
(6) Usually no negative impact on digestability.

Presently, the following compositions have proven to show the strongest synergistic antimycotic effect:
(i) malic acid and/or caprylic acid+cinnamon aldehyde
(ii) malic acid and/or caprylic acid+cinnamon aldehyde and oregano oil
(iii) malic acid and/or caprylic acid+grapefruit seed extract
(iv) malic acid and/or caprylic acid+cinnamon extract and thyme oil
(v) malic acid and/or caprylic acid+thyme oil and oregano oil
(vi) malic acid and/or caprylic and/or citric acid+cinnamon oil and vanillin
(vii) malic acid and propionic acid+vanillin and/or cinnamon oil
(viii) cinnamon aldehyde+grapefruit seed extract and/or vanillin

The preferred ratio of the compound(s) of group (a) or (a′) and the compound(s) of group (b) is in the range from 95:5 to 70:30. These preferred combinations are added to the food or feed product in a preferred amount of 0.1% to 1.2%, more preferably from 0.25% to 0.9%, by dry weight of the food or feed product.

Instead of using a pure organic acid or mixture of pure organic acids from group (a) or group (a′), products may be used containing such organic acids as a result of a fermentation. A presently considered example are fermented dextrose powders such as MicroGARD® 200 being a composition of cultured dextrose and maltodextrin. Although a certain effectiveness of such products against yeasts and moulds are already known, combination with at least one compound of group (b) to form a composition according to the present invention has again shown a strong synergistic effect.

The extract may be provided for in liquid, solid, resinous or partly volatile form. They may be fractionated, distilled, crystallized, separated or otherwise purified. The compositions may be applied in the recipe matrix and/or in a coating applied to the products. In order to facilitate appropriate distribution of the composition in the recipe matrix and/or in the coating, appropriate emulsifiers, such as e.g. lecithin, may be used. Also, the process of application of the composition into the recipe matrix and/or the coating might have an impact on availability for protection against spoilage.

As some of the components of group (b) may be sensitive towards oxidation, antioxidants, such as e.g. tocopherols, might be added in order to improve the stability of the antimycotic composition throughout the shelf life of the product.

It is also been noticed that the presence of a certain amount of sodium chloride (NaCl) in the composition and/or in the product can be beneficial for the overall antimycotic performance. A preferred range of sodium chloride in the finished product is between 1.0 and 2.0% by weight.

Inclusion of some of these extracts may also provide additional benefits in food or feed products besides the antimycotic effect. For example, the compositions may also provide anti-bacterial effects, bacteriostatic effects, mycostatic effects, pleasant aroma, flavor, color or texture or health benefits.

Although preferred, the present invention is not only related to the use of the antimycotic cocktail for intermediate moisture pet food products. Rather, it could also be used in refrigerated pet food systems, in human confectionary systems, in human foods, or as part of an antimycotic system in a packaging for a food or feed product.

The typical concentration of the composition in the ratio of the components thereof vary, depending on specific components chosen. Although someone skilled in the art could easily determine the respective amounts and ratios on the basis of those as, for example, described in the examples hereof, preferred ranges for the content in the finished product of specific components are given herein below:

| | | |
|---|---|---|
| cinnamon oil | 0.05-0.5 | wt. % |
| cinnamon aldehyde | 0.005-0.04 | wt. % |
| grapefruit seed extract | 0.01-0.05 | wt. % |
| vanillin | 0.01-0.1 | wt. % |
| caprylic acid/sodium caprylate | 0.01-0.60 | wt. % |
| cinnamic acid | 0.005-0.04 | wt. % |
| malic acid | 0.1-1.0 | wt. % |

In case that the antimycotic cocktail might have a negative impact on the palatability of the product, palatant/flavor ingredients or a masking system might be added, as known from the prior art.

### EXAMPLES

### Strain Cocktail Used for Inoculation:

Zygosaccharomyces baillii
Saccharomyces cerevisiae
Zygosaccharomyces rouxii
Aspergillus niger
Penicillium aurantogriseum
Wallemia sebi
Eurotium repens
Eurotium herbariorum

### Method

Prior to the tests, the yeasts were grown in Malt Extract Broth (MEB, Oxoid, CM0057) at 25° C. for 72 hours. The Aspergillus niger and Penicillium aurantogriseum were grown on pre-poured plates and agar slopes of Malt Extract Agar (MEA, Lab M, Lab 37) at 25° C. for 1 week. The Eurotium repens was grown on pre-poured plates and agar slopes of Potato Dextrose Agar (PDA, Oxoid CM0139) at 25° C. for 1 week. The Wallemia sebi and Eurotium herbariorum were grown on pre-poured plates and agar slopes of Wort Agar (WA, Oxoid, CMO247) at 25° C. for 1 week.

On the day of the test, the moulds were harvested from the surface of the agar plates and slopes by adding sterile distilled water and scraping the surface growth into the water. The levels of yeasts and moulds in the diluents were determined microscopically using a haemocytometer.

The yeasts and moulds were diluted and mixed together as a cocktail to achieve a level of approximately 10⁷ colony forming units (cfu) per gram. Addition of 0.1 ml of the cocktail to the broths would achieve a final level of 10⁵ cfu/ml.

### Preparation of Broths

### The Preparation of the Individual Broths was as Follows:

### Broth at Aw 0.75

1 litre MEB was added to 1440 g glycerol. The pH was adjusted to 6.31 and the broths were dispensed into 10 ml amounts. Initial studies had shown that if the pH was adjusted to 6.0 prior to autoclaving, the resultant pH was 5.9. Therefore the broth was adjusted in order to achieve as close to the desired pH of 6.0 after autoclaving as possible.

Following autoclaving, the pH was measured at 6.18 and the Aw at 0.71. It was established that addition of 0.5 ml of sterile water would increase the Aw to 0.75. Therefore, 0.4 ml of sterile distilled water was added to the broths as they would be inoculated with 0.1 ml of inoculum, thus giving a total of 0.5 ml.

### Broth at Aw 0.85

1 litre MEB was added to 700 g glycerol. The pH was adjusted to 6.32 and the broths were dispensed into 10 ml amounts.

Following autoclaving, the pH was measured at 6.31 and the Aw at 0.82. It was established that addition of 0.3 ml of sterile water would increase the Aw to 0.85. Therefore, 0.2 ml of sterile distilled water was added to the broths as they would be inoculated with 0.1 ml of inoculum, thus giving a total of 0.3 ml.

The compositions of the antimycotic cocktails used to be added to the broths are indicated in Table 1.

Table 2 shows the growth results of the antimycotic cocktails in the broth model system wherein NG indicates no visible growth after 90 days at 25° C. and NT has the meaning “not tested”.

TABLE 1
Composition of antimycotic cocktails according to the invention

| | Example 1 | Example 2 | Example 3 | Example 4 | Example 5 | Example 6 | Example 7 |
|---|---|---|---|---|---|---|---|
| Antimycotic | relative | relative | relative | relative | relative | relative | relative |
| Cocktail | conc in % | conc in % | conc in % | conc in % | conc in % | conc in % | conc in % |
| caprylic acid | 80 | 40 | 85.7 | | 7.3 | 2.8 | |
| malic acid | | | | | 90.9 | 94.4 | |
| cinnamon | 20 | | 14.3 | 33.3 | 1.8 | 2.8 | 33.3 |
| aldehyde | | | | | | | |
| grapefruit seed | | 60 | | | | | 66.7 |
| extract | | | | | | | |
| vanillin | | | | 66.7 | | | |

TABLE 2
Growth results

Time to observed growth

| Cocktails | Aw 0.75 | Aw 0.85 |
|---|---|---|
| Example 1 | NG | NG |
| Example 2 | NG | NG |
| Example 3 | NG | NG |
| Example 4 | NG | NT |
| Example 5 | NG | NG |
| Example 6 | NG | NG |
| Example 7 | NG | NT |

The test results clearly show a high antimycotic effect of the respective compositions, both with a water activity of 0.75 and a water activity of 0.85.

Preliminary results on pet food products have been conducted. The total concentration of the various antimycotic cocktails applied to the pet food product can be seen from Table 3.

TABLE 3
Total concentration of antimycotic cocktails on pet food product

| Cocktails | Total concentration of cocktail on product |
|---|---|
| Example 1 | 0.10 wt. % |
| Example 2 | 0.05 wt. % |
| Example 3 | 0.07 wt. % |
| Example 4 | 0.06 wt. % |
| Example 5 | 0.55 wt. % |
| Example 6 | 0.53 wt. % |
| Example 7 | 0.03 wt. % |

In stability tests and feeding tests it has been demonstrated that pet food products to which anti-mycotic cocktails according to the present invention have been applied show a superior shelf stability as well as a very good pet palatability without any negative impact on the digestibility.

Further tests have been conducted to establish synergistic activity of the antimycotic cocktails of the present invention. These tests are based on determination of the Minimum Inhibition Concentration (MIC).

For the tests, cell culture plates with YG broth as a base were used. Test samples were inoculated with a conidial suspension of Aspergillus niger DSMZ 737 and incubated for 3 days at 30° C. The targeted spore count was at approximately 10⁵ spores/ml. As Minimal Inhibition Concentration (MIC) the concentration of active ingredient with no visible growth of mycelium in the cavity was defined. In addition, results were confirmed microscopically and in a culture on YGC plates.

To dissolve the different mixtures, one of the following media was used as appropriate: distilled water; distilled water+0.5% Tween 80; distilled water+0.4% Lecithine.

In a first series of tests, mixtures of cinnamon aldehyde, thyme oil and malic or caprylic acid were tested. The MIC of cinnamon aldehyde alone has been determined to be 200 ppm, the MIC of thyme oil alone to be 400 ppm, the MIC of caprylic acid alone to be 2000 ppm, and for malic acid alone, there is no MIC, as this substance did not show any inhibitory properties.

A mixture of 100 ppm cinnamon aldehyde and 200 ppm thyme oil and a mixture of 50 ppm cinnamon aldehyde and 300 ppm thyme oil did not show any inhibition. However, when adding 2250 ppm malic acid and/or 600 ppm caprylic acid, the mixtures show clear inhibition under the test conditions indicating a synergistic effect of the antimycotic cocktails.

In a second series of tests, mixtures of origanum oil, thyme oil and malic acid or caprylic acid were tested. The MIC of origanum oil alone was determined to be 400 ppm.

A mixture of 300 ppm thyme and 100 ppm origanum oil, a mixture of 200 ppm of each thyme oil and origanum oil and a mixture of 100 thyme oil and 300 ppm origanum oil did not show any inhibition effect. However, adding of 2250 ppm malic acid and/or 600 ppm caprylic acid resulted in a clear inhibition under the test conditions, so that also in this case a synergistic activity has been shown.

The features disclosed in the foregoing description and in the claims may, both separately and in any combination thereof, be material for realizing the invention in diverse forms thereof.

1. Composition for prevention against spoilage by moulds and yeasts comprising, as the only antimycotic agents, at least one compound from group (a) and at least one compound from group (b):
(a) organic acids selected from the group consisting of caprylic acid, cinnamic acid, propionic acid, butyric acid, lactic acid, tartaric acid and fumaric acid, and salts thereof
(b) plant or fruit extracts, the oily phases of plant or fruit extracts, and monosubstances derived from such extracts or oily phases thereof.

2. Composition according to claim 1, wherein the plant or fruit extract from group (b) is selected from cinnamon extract, in particular extract of cinnamon bark or cinnamon leaf, thyme extract, oregano extract, marjoram extract, lemon grass extract, cassia extract, geranium extract, grapefruit seed extract, cranberry extract and bilberry extract.

3. Composition according to claim 1, wherein the oily phase from group (b) is selected from the group consisting of cinnamon oil, lemon grass oil, thyme oil, lemon myrrth oil, oregano oil, tea-tree oil and clove oil.

4. Composition according to claim 1, wherein the monosubstance from group (b) is selected from the group consisting of cinnamon aldehyde, vanillin and functionally equivalent derivatives thereof.

5. Composition according to claims 1, wherein the organic acid from group (a) is caprylic acid, cinnamic acid, propionic acid or one or more salts thereof.

6. Composition according to claims 1, wherein the component(s) from group (a) and the component(s) from group (b) are present in a mass ratio of from 20:80 to 98.5:1.5, preferably from 70:30 to 98.5:1.5.

7. A method of protecting food or feed products from the growth of moulds and yeasts comprising the step of using a composition comprising, as the only antimycotic agents, at least one compound of group (a′) and at least one compound of group (b), as defined in claims 1, or a content of at least two compounds from group (b), as defined in claims 1, wherein group (a′) comprises straight, branched or cyclic, mono- or polyvalent organic acids having 3 to 10 carbon atoms, optionally hydroxy or oxo substituted.

8. The method of claim 7 wherein said food or feed products are selected from the group consisting of a pet food product, a human food product, a confectionary product or as part of a packaging for a food or feed product.

9. The method of claim 7, wherein the organic acid from group (a′) is selected from caprylic acid, cinnamic acid, levulinic acid, malic acid, propionic acid, butyric acid, lactic acid, tartaric acid, ascorbic acid, fumaric acid, citric acid, and salts thereof.

10. The method of claim 7, wherein the component(s) from group (a′) and the component(s) from group (b) are present in a mass ratio of from 20:80 to 98.5:1.5, preferably from 70:30 to 98.5:1.5.

11. Food or feed product with a content of from 0.01% to 2.5%, preferably from 0.1% to 1.2%, most preferably from 0.25% to 0.9%, by dry weight of the food or feed product, of a composition selected from the group consisting of compositions according to claims 1 or a composition as defined in claim 7.

12. Food product according to claim 11, wherein the food product is a pet food product.

13. Pet food product according to claim 12, having a moisture content of from 10 to 40 wt.-% and a water activity in the range from 0.60 to 0.90.

14. Pet food product according to claim 13, having a water activity of from 0.65 to 0.85.
